(19) United States
(12) Patent Application Publication
(10) Pub. No.: US 2022/0058621 A1
(43) Pub. Date: Feb. 24, 2022

(54) METHODS AND SYSTEMS FOR FACILITATING MANAGING OF PAYMENTS MADE USING DIGITAL WALLETS

(71) Applicant: David Genon Wofford, Palm Harbor, FL (US)

(72) Inventor: David Genon Wofford, Palm Harbor, FL (US)

(21) Appl. No.: 17/408,341

(22) Filed: Aug. 20, 2021

Related U.S. Application Data
(60) Provisional application No. 63/068,076, filed on Aug. 20, 2020.

(51) Int. Cl. G06Q 20/36; G06N 20/00; G06Q 20/10

(52) U.S. Cl. CPC G06Q 20/363; G06Q 20/102; G06N 20/00; G06Q 20/3674

(57) ABSTRACT

Disclosed herein is a method for facilitating managing of payments made using digital wallets. Accordingly, the method may include receiving, using a communication device, payment request data from a device, identifying, using a processing device, the digital wallet based on the digital wallet identifier, retrieving, using a storage device, digital wallet data associated with the digital wallet based on the identifying of the digital wallet, analyzing, using the processing device, the digital wallet data and the payment request data using a machine learning model, determining, using the processing device, an account preferability for accounts based on the analyzing, identifying, using the processing device, an account from the accounts based on the determining of the account preferability, and authorizing, using the processing device, a transaction for the payment amount from the account based on the identifying of the account.

The current application claims a priority to the U.S. provisional patent application Ser. No. 63/068,076 filed on Aug. 20, 2020.

### FIELD OF THE INVENTION

Generally, the present disclosure relates to the field of data processing. More specifically, the present disclosure relates to methods and systems for facilitating the managing of payments made using digital wallets.

### BACKGROUND OF THE INVENTION

The field of data processing is technologically important to several industries, business organizations, and/or individuals.

Payment systems have played a crucial role in the development of trade, commerce, technology, and more. Traditionally, a single-source payment system was necessary to attribute an objective and concrete value to goods and services. Thus, payment systems facilitated the development and the growth of businesses, projects, foundations, and more. The currency selected by the payment system usually involves a physical object or a collection of physical objects with a given value.

When a currency is not available, oftentimes the parties involve opening a line of credit. Further, the line of credit allows two parties to enter into an agreement, where one party provides the goods or services, and the receiving party pays for the goods and services down the line. The concept of credit then creates a sense of virtual money, or an ability to acquire any goods or services without the need for physical currency.

In actuality, the concept of currency is not only widely known, but current methods allow the transfer of currency from one party to another almost instantly. Thus, payment systems and methods comprise technological augmentations which provide users not only with instant and complete control over their funds, but also tools for quick and safe payments, money transfer, investment, credit control, and more.

Unfortunately, the same advantage of various payments systems, banks, lines of credit, and vendor point of sale systems is the same challenge or obstacle. The presence of multiple payments systems and methods creates a compatibility and integration problem that poses a challenge when developers are not keeping in mind compatibility with platforms or software. Existing technologies do not provide full and seamless integration of all payment systems to centralize the process and procedure into a single management system.

Therefore, there is a need for improved methods and systems for facilitating the managing of payments made using digital wallets that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating managing of payments made using digital wallets, in accordance with some embodiments. Accordingly, the method may include receiving, using a communication device, payment request data from at least one device. Further, the method may include identifying, using a processing device, the digital wallet based on the digital wallet identifier. Further, the method may include retrieving, using a storage device, digital wallet data associated with the digital wallet based on the identifying of the digital wallet. Further, the method may include analyzing, using the processing device, the digital wallet data and the payment request data using at least one machine learning model. Further, the method may include determining, using the processing device, an account preferability for the one or more accounts based on the analyzing. Further, the method may include identifying, using the processing device, at least one account from the one or more accounts based on the determining of the account preferability. Further, the method may include authorizing, using the processing device, a transaction for the payment amount from the at least one account based on the identifying of the at least one account.

Further disclosed herein is a system for facilitating managing of payments made using digital wallets, in accordance with some embodiments. Accordingly, the system may include a communication device configured for receiving payment request data from at least one device. Further, the system may include a processing device communicatively coupled with the communication device. Further, the processing device may be configured for identifying the digital wallet based on the digital wallet identifier. Further, the processing device may be configured for analyzing digital wallet data and the payment request data using at least one machine learning model. Further, the processing device may be configured for determining an account preferability for the one or more accounts based on the analyzing. Further, the processing device may be configured for identifying at least one account from the one or more accounts based on the determining of the account preferability. Further, the processing device may be configured for authorizing a transaction for the payment amount from the at least one account based on the identifying of the at least one account. Further, the system may include a storage device communicatively coupled with the processing device. Further, the storage device may be configured for retrieving the digital wallet data associated with the digital wallet based on the identifying of the digital wallet.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating managing of payments made using digital wallets, in accordance with some embodiments.

FIG. 3 is a flow chart of a method for facilitating managing of payments made using digital wallets, in accordance with some embodiments.

FIG. 4 is a flow chart of a method for allocating the one or more payment amount portions for facilitating managing of payments made using digital wallets, in accordance with some embodiments.

FIG. 5 is a flow chart of a method for allotting the at least one first payment amount portion for facilitating managing of payments made using digital wallets, in accordance with some embodiments.

FIG. 6 is a flow chart of a method for allotting the at least one payment amount portion for facilitating managing of payments made using digital wallets, in accordance with some embodiments.

FIG. 7 is a flow diagram of a method for facilitating managing of payments made using digital wallets, in accordance with some embodiments.

FIG. 8 is a tabular representation of user plans associated with the disclosed system for facilitating managing of payments made using digital wallets, in accordance with some embodiments.

FIG. 9 is a tabular representation illustrating features provided by some conventional systems, in accordance with some embodiments.

FIG. 10 is a flow diagram of a method for facilitating registration and account maintenance, in accordance with some embodiments.

FIG. 11 is a flow diagram of a method for facilitating multi-card transactions, in accordance with some embodiments.

FIG. 12 is a flow diagram of a method for facilitating registration and account maintenance, in accordance with some embodiments.

FIG. 13 is a flow diagram of a method for facilitating single-card transactions, in accordance with some embodiments.

FIG. 14 is a flow diagram of a method for facilitating multi-card transactions, in accordance with some embodiments.

FIG. 15 is a flow chart of a baseline method associated with the disclosed system for facilitating managing of payments made using digital wallets, in accordance with some embodiments.

FIG. 16 is a flow chart of a supplemental method associated with the disclosed system for facilitating managing of payments made using digital wallets, in accordance with some embodiments.

FIG. 17 is a flow chart of an enhanced method associated with the disclosed system for facilitating managing of payments made using digital wallets, in accordance with some embodiments.

FIG. 18 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating managing of payments made using digital wallets, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), and a biometric sensor (e.g. a fingerprint sensor).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating managing of payments made using digital wallets. Further, Passport Wallet, an exemplary embodiment of the disclosed system herein, is an automated financial smart card management system that may be accessed via a standard credit card, online website, or mobile application (i.e. iOS, Android, etc.) platform.

Further, the disclosed system may be configured for total integration of payment methods and various additional modules regarding rewards, budgets, trends, crypto currency, and other personal relevant financial information or preferences. In addition, the disclosed system provides predictive analysis based on algorithms, machine learning, and artificial intelligence programs to better inform and automatically or manually assist the user in making better-informed purchasing decisions. The disclosed system may be configured for financial smart card management. Further, the disclosed system may be configured for automatic selection and allocation of expenses amongst a single card or card application, or a plurality of cards for different transactions. The disclosed system may be configured for inspecting available balances from the associated plurality of accounts and dividing the expenses amongst the corresponding accounts.

Thus, the disclosed system may include a platform where all payment systems information, accessibility, and control are based on a single security management platform. Further, the disclosed system may provide full and seamless integration of all payment systems to centralize the process and procedure into a single management system. Further, the disclosed system may provide the user with a plurality of modules that also aim to enhance the user's experience and facilitate the user.

Furthermore, the disclosed system may be configured for automatic selection and allocation of expenses amongst the corresponding associated accounts through the use of algorithms, machine learning (ML), and artificial intelligence (AI).

If an account from the corresponding associated accounts does not have sufficient funds, the disclosed system terminates the card with zero balance and inspects the remaining accounts to determine which accounts have sufficient funds for the difference in payment.

Further, the disclosed system may include a plurality of modules that may include a user registration module, a banking authorization module, an add and check account balance module, a funds transfer and transfer receipt module, payment for bills module, and an offer module. The plurality of modules comprises basic features and modules that a user engages with the most often. Furthermore, additional modules associated with the disclosed system may include more user-oriented configurations available such as a loyalty card module, a loyalty reward offer module, a crypto currency module, a loyalty card with cross-promotion advertising campaigns module, a gift card module, push-notifications module, a geo-targeting module, an exclusive offers module, and a membership card/discount module.

Additionally, the geo-targeting module allows a user to locate active geotags on a map. When the geotag is selected, the disclosed system generates a notification regarding new campaigns for that particular business/service and cross-promoted related businesses/services.

Furthermore, the disclosed system may be configured for stepped authorization for bank cards. For instance, if an incoming request occurs via a method such as a Near Field Communication (NFC) chip, the disclosed system facilitates cycling through a list of authorization parameters within a corresponding card. Further, the authorization parameters include, but are not limited to a percentage utilization parameter, a card limits parameter, and a benefits preference parameter. Additionally, the disclosed system may be associated with additional custom configurations such as live updates and return management.

Additionally, further financial smart card-wallet components associated with the disclosed system provide the user full access and control over financial information. For instance, the disclosed system may include a plurality of personal finance modules such as a credit score trends module, a budgeting module, and a scheduled card payments module. The plurality of personal finance modules is easily accessed via a personal finance application interface.

Furthermore, the disclosed system may be associated with a plurality of Application Programming Interfaces (APIs) that enhance and provide further insight and accessibility of information. The plurality of APIs is divided into baseline methods, supplemental methods, and enhanced methods. The baseline method comprises a digital credential loading module and a top-of-wallet module.

Additionally, the disclosed system may be configured for automatically selecting and allocating expenses for different transactions. Further, the disclosed system may inspect available balances from the associated accounts within the passport wallet, and determines which account has sufficient funds based on the transaction.

Similarly, if an account does not have sufficient funds, the disclosed system inspects the remaining accounts to determine which account has sufficient funds for the difference in payment.

The disclosed system is compatible and integrates seamlessly with all existing payment method systems such as Visa, Mastercard, Discover, and PayPal.

Further, the plurality of modules incorporates the various paying methods and most commonly used applications to integrate all platforms and systems into a single unit.

Further, in an embodiment, a setup method to authenticate and verify a user is disclosed. The setup method comprises a user authentication step where the disclosed system may determine the user is real. Further, the setup method may include the user selecting the desired configurations for authorized users. Once these steps are complete, the personal information setup step is next. In this step, the user can input the user's information regarding identity, address, and other required information for payment purposes. Further, the setup method may include an account assignation or account modification where the accounts/cards are added, changed, or deleted from a user account. Furthermore, during the account assignation or modification step, a bank verification step, and a retrieve card benefits step, followed by a store charge distribution.

Further, exception handling, live updates, and return management are some of the other features and additional custom configurations available to the user for the disclosed system. Further, the live update module generates an update on a user's card or app from the disclosed system. The user's card comprises information regarding an account or a plurality of accounts. An activation process allows the card to function and operate, meanwhile providing a balance of the account(s), a history of transactions, a credit limit, and a list of benefits available/used.

The disclosed system inspects all available balances from the associated accounts within the passport wallet, and through a series of steps determines which account has sufficient funds based on the transaction.

For instance, during a charge transaction occurring at a point of sale system or a website, goods or services are being exchanged for currency via a credit card or debit card; a typical transaction. In the case of a single card being utilized, the corresponding issuing bank connects to a passport database associated with the disclosed system. The passport database comprises the various information initially disclosed by the user and saved into the passport database at the registration and account maintenance step.

Once the connection is successful, the disclosed system retrieves information regarding the available funds. If there are sufficient funds, the charge transaction is authorized. If there are not sufficient funds, the sale is terminated.

In the case of two or more debit cards or credit cards are being utilized, the corresponding issuing bank similarly connects to the passport database as previously described. Once the connection is successful, the disclosed system retrieves information regarding the multiple funds linked to the multiple cards.

In a scenario where all cards used for the transaction have sufficient funds, then the charge is divided amongst the cards based on user predetermined amounts. In the case, one or more debit card(s) or credit card(s) have insufficient funds, the present invention automatically distributes the difference amongst the remaining available debit card(s)/credit card(s) based on fund availability. Thus, any card that does not have sufficient funds is terminated during the process with zero balance for that corresponding charge transaction.

The digital credential loading module comprises an API token service provisioning and a lifecycle management API. The top-of-wallet module comprises a check eligibility API, an approved provisioning API, a cardholder verification method API and a send pass code API. Subsequently, the top-of-wallet comprises the following plurality of token APIs, an inquiry token API, an inquiry by Personal Area Network (PAN) token API, a lifecycle token API, a PAN lifecycle token API, a create notification token API, and a notification token API. Furthermore, the supplemental methods comprise a card benefit eligibility module, a relevant offers module, a request virtual account and set controls module, a credential-on-file experience module, a generation of dynamic Card Verification Value 2 (CVV2) codes module. The card benefit eligibility module comprises a card eligibility service API for a Payment Card Industry (PCI) compliant vendor and a card eligibility service iframe API for a non-PCI compliant vendor. Additionally, the relevant offers module comprises an offer data API and a reference data API. Furthermore, the request virtual account and set controls module comprises a request virtual account API and a get security code API. The remaining modules from the supplemental methods comprise their corresponding APIs, as well as the modules from the enhanced methods. All APIs are designed to facilitate and provide a better experience when dealing with payment methods and transactions.

Thus, the enhanced methods aim to reduce inconvenient wait times and provide easier management of funds when traveling. For instance, the enhanced methods comprise a check prediction and reduce wait module with its corresponding APIs, an enhanced merchant information module with its corresponding APIs, an enhanced travel experience module with all its corresponding APIs, an enhanced funds transfer module with its corresponding APIs, and an enhanced accounts payable module with all its corresponding APIs.

Further, there may be 3.1 credit cards an average person has. Further, the average credit card debt per person may be $6,354. Further, the average credit score may be 675. Further, the average credit utilization rate may be 30%. Further, there may be 1.5 billion credit cards are there in the U.S. Further, credit card debt may be $815 billion in the U.S. Further, 67% of people have a credit card.

New and young credit card users are often limited to their purchasing power due to poor or new credit history. Further, credit card companies set card user limits. Further, in some conventional systems, balance transfers can take 1-5 days, with additional fees added to the transfer process. Further, multiple card balances may not be shared interchangeably amongst one another. Further, card security may be easily jeopardized if the card is lost, stolen or POS and/or website is compromised. Further, in some conventional systems, consumers need to open new credit accounts if they wish to expand credit limits or receive special offers.

Further, the first multi-purpose credit card associated with the disclosed system allows credit card users to maximize spending and access multiple accounts. Further, the disclosed system may enhance security protection using added credit account layer. Further, the disclosed system may expand user options. Further, the disclosed system may allow the user to access multiple reward accounts simultaneously. Further, the disclosed system may provide biometric user access. Further, the disclosed system may facilitate tracking budgets and creating the monthly, holiday, and special occasion budgets (notifies when the budget is reached or short). Further, the disclosed system may track credit card balances and alerts the user when the balance gets close to the limit. Further, the disclosed system may allow the users to shift and/or pay down balance to ½ balance, thus improving the FICO score. Further, the disclosed system may develop a first social finance charge card network bringing global purchases to the consumers' fingertips.

Further, the disclosed system may be associated with three main sources to generate revenue, namely, service charges, licensing fees, and website and mobile app advertisement. Further, the service charges associated with a standard account may include no service fees under $300. Further, anything over $500 may receive a 0.005% monthly service charge. Further, the service charges associated with a gold account for $500-$2499 may be 0.009% service account. Further, the service charges associated with a platinum Account for $2500-unlimited may be 0.015%. Further, the service charges associated with a business user account may be 0.008%. If the user (or customer) goes above the set price, charges will roll over and reflect the next higher user charge line. Further, advertisement revenue associated with the website may be $1.25 per Thousand views (PPM). Further, advertisement revenue associated with the mobile app may be 0.75 per Thousand views.

Further, the disclosed system may be marketed through co-branding & infinity branding such as radio stations, sporting venues, charity, entertainment, hospitality, travel outlets. Further, the disclosed system may be marketed through public relations management at entertainment, sporting, charity. Further, the disclosed system may be marketed through social media outlets such as Facebook™, Twitter™, etc. Further, strategic segment advertisement (mailers) associated with the disclosed system may include 18-36 years old, Young Bus Pro, and Heads-of Households. Further, issuing bank co-branding with Visa, Mastercard, Discover, AmEx, etc. may be associated with added benefits such as no additional credit checks, no additional extended funding lines of credit, no collection or late payment issues, new lines of profit, new marketing opportunities, and new customers.

Further, the passport credit card associated with the disclosed system may include a credit card that may be plastic. Further, the passport credit card may be associated with a biometric (i.e. fingerprint, palm, or eye scan). Further, virtual PIN cards associated with the disclosed system may be associated with mobile app & websites.

Further, monthly costs & fees associated with the credit card may include interchange costs, transaction costs, and monthly usage fees. Further, the average interchange cost may be 1.60% for card-present businesses (POS swipe) and 1.90% for card-not-present businesses (Internet Web/Mobile App). Further, the monthly transaction costs associated with the credit card may be $300 monthly spending×0.005 monthly Passport user fee=$1.50, $300 monthly spending×0.019 processing fee=$5.7, and $300 monthly spending×0.0028 operational costs=0.84. Further, total monthly service costs may be $5.7+$1.50+0.84=$8.04. Further, the average credit card transaction fees charged by VISA or MASTER CARD are passed on to the card holder as part of their monthly processing fee.

Further, the disclosed software platform may provide links to favorite websites and online channels associated with sports. Further, the disclosed software platform may facilitate auto-filling credit card data when making online purchases. Further, the disclosed system may facilitate ordering tickets, reserving seats, and advertising the latest discounts and promotions.

Further, the disclosed software platform may provide links to favorite websites such as concerts, forums, theaters, etc. associated with entertainment. Further, the disclosed software platform may facilitate auto-filling credit card data when making online purchases. Further, the disclosed software platform may facilitate ordering tickets, purchasing merchandise, and advertising the latest discounts and promotions.

Further, the disclosed software platform may provide offers prepaid lunch cards/meal tickets associated with colleges and universities. Further, the disclosed software platform may offer online school catalog supplies. Further, the disclosed software platform may provide links to educational websites such as schools, universities, TV channels (Discover, History, etc.). Further, the disclosed software platform may include a running tab associated with the colleges and universities.

Further, the disclosed software platform may facilitate reserving tables and rooms at hotels, restaurants, and bars. Further, the disclosed software platform may providers discounts and promotions. Further, the disclosed software platform may facilitate sending group invites, Further, the disclosed software platform may facilitate providing maps and information on hotel/restaurants. Further, the disclosed software platform may include a running tab. Further, the disclosed software platform may provide a room key option.

Further, the disclosed software platform may facilitate booking airline tickets associated with the airline and car rental agencies. Further, the disclosed software platform may facilitate reserving rental cars.

Further, the disclosed system may be configured for consolidating available funds, decreasing or increasing personal spending limits, offering new venues to purchase, offering an added line of protection to their credit card, and offering customized web and mobile app pages.

Further, in an embodiment, the disclosed system may be configured for user registration. Further, the disclosed system may be configured for authorizing a banking account (or credit card). Further, the disclosed system may be configured for providing an opportunity to add and check account balances. Further, the disclosed system may be configured for transferring funds and receipt. Further, the disclosed system may be configured for payment for bills. Further, the disclosed system may be configured for providing an opportunity to use offers (discount coupons, personal funds return).

Further, the passport credit card may be a loyalty card with a loyalty reward offer. Further, the loyalty card may be associated with crisscrossed advertising campaigns, gift cards. Further, the disclosed system may be associated with push notifications. Further, geo-targeting may allow the user to locate active geotags on the map. When the client clicks them, the client may get a notification about some new campaigns, exclusive offers, and membership cards/discounts, etc.

Further, the disclosed system may be configured for setting up a wallet. Further, the disclosed system may be configured for performing user authentication. Further, authorized users may perform a personal info setup using the disclosed system. Further, the disclosed system may add/change/delete cards associated with the user. Further, the disclosed system may be configured for verifying bank details and retrieving card benefits. Further, the disclosed system may be configured for storing charge distribution.

Further, the disclosed system may be configured for stepped authorization to card banks. Further, Further, the disclosed system may be configured for receiving an incoming request from a card using NFC Chip. Further, the disclosed system may be configured for cycling through the card list for authorization. Further, the authorization may be associated with % utilization, card limits, and benefits preference. Further, the disclosed system may be configured for exception handling. Further, the disclosed system may be configured for wallet updates. Further, the disclosed system may be configured for the management of returns.

Further, the disclosed system may be configured for performing daily card update from an issuer that may include activation/status, balance, transactions, credit limit, and benefits availability/usage.

Further, the disclosed system may be configured for providing personal finance based on credit score trends and budgeting. Further, the disclosed system may be configured for processing scheduled card payments. Further, the disclosed system may provide a personal finance application interface.

Further, the disclosed system may be configured for providing base functionality that may include digital credential loading. Further, the disclosed system may keep your card top-of-wallet. Further, the disclosed system may be configured for providing added benefits. Further, the added benefits may be associated with card benefit eligibility. Further, the disclosed system may be configured for providing relevant offers. Further, the disclosed system may be configured for requesting virtual accounts and setting controls. Further, the added benefits may be associated with the credential-on-file experience. Further, the disclosed system may be configured for the generation of dynamic CVV2 codes.

Further, the disclosed system may be configured for checking predictions and reduce wait. Further, the disclosed system may be configured for providing enhanced merchant information. Further, the disclosed system may be configured for providing an enhanced travel experience. Further, the disclosed system may be configured for performing enhanced funds transfer and providing enhanced accounts payable experience.

Further, the disclosed system be associated with APIs for facilitating Visa token service provisioning and lifecycle management.

Further, keep your card top-of-wallet APIs associated with the disclosed system may facilitate checking eligibility, approving provisioning, getting cardholder verification methods, and sending passcode.

Further, token API associated with the disclosed system may facilitate providing inquiry, an inquiry by PAN, lifecycle, PAN Lifecycle. Further, the token APIs associated with the disclosed system may be facilitating creating a notification.

Further, easy benefit eligibility validation API associated with the disclosed system may facilitate providing visa card eligibility service (PCI compliant vendor) and Visa Card Eligibility Service iFrame (non-PCI compliant vendor). Further, the disclosed system may facilitate providing data API and Reference Data API. Further, the disclosed system may be associated with virtual assistant API and security code API.

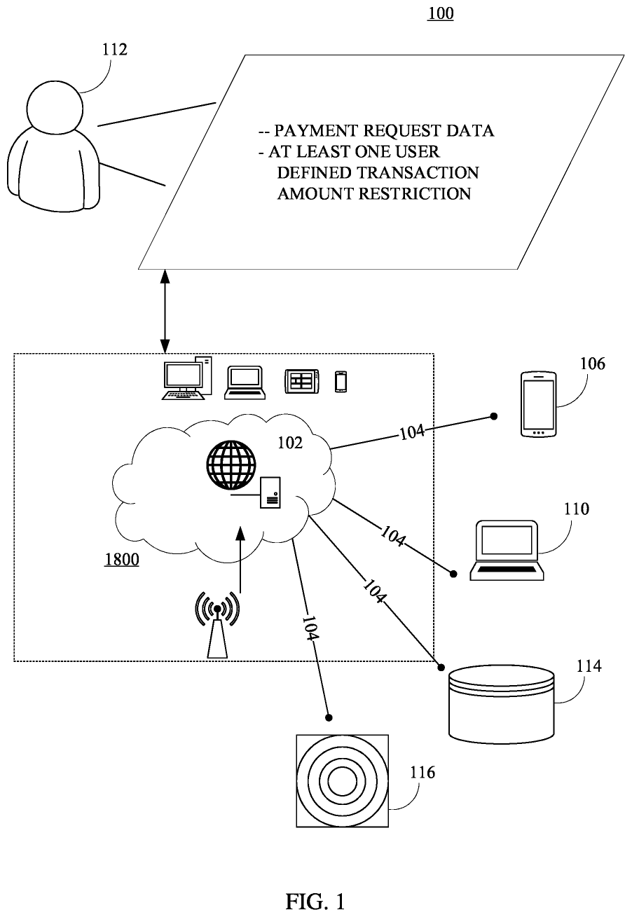

FIG. 1 is an illustration of an online platform 100 consistent with various embodiments of the present disclosure. By way of non-limiting example, the online platform 100 for facilitating managing of payments made using digital wallets may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1800.

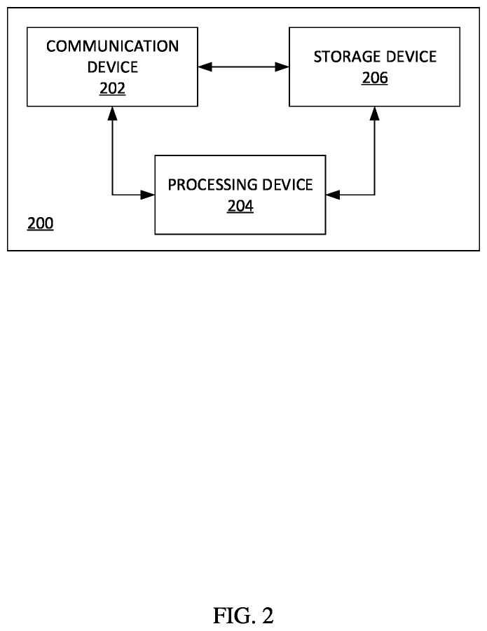

FIG. 2 is a block diagram of a system 200 for facilitating managing of payments made using digital wallets, in accordance with some embodiments. Accordingly, the system 200 may include a communication device 202 configured for receiving payment request data from at least one device. Further, the payment request data may include a payment amount and a digital wallet identifier associated with a digital wallet. Further, the system 200 may include a processing device 204 communicatively coupled with the communication device 202. Further, the processing device 204 may be configured for identifying the digital wallet based on the digital wallet identifier. Further, the processing device 204 may be configured for analyzing digital wallet data and the payment request data using at least one machine learning model. Further, the digital wallet data may include one or more account data associated with one or more accounts of the digital wallet. Further, the processing device 204 may be configured for determining an account preferability for the one or more accounts based on the analyzing. Further, the processing device 204 may be configured for identifying at least one account from the one or more accounts based on the determining of the account preferability. Further, the processing device 204 may be configured for authorizing a transaction for the payment amount from the at least one account based on the identifying of the at least one account. Further, the payment amount may be transacted from the at least one account based on the authorizing. Further, the system 200 may include a storage device 206 communicatively coupled with the processing device 204. Further, the storage device 206 may be configured for retrieving the digital wallet data associated with the digital wallet based on the identifying of the digital wallet.

Further, in some embodiments, the one or more account data may include one or more funds available in the one or more accounts. Further, the analyzing may include comparing the one or more funds with the payment amount. Further, the account preferability may include an account fund sufficiency of the one or more accounts. Further, the determining of the account preferability may include determining the account fund sufficiency for the one or more accounts based on the comparing. Further, the identifying of the at least one account from the one or more accounts may be based on the determining of the account fund sufficiency.

Further, in some embodiments, the processing device 204 may be configured for dividing the payment amount into one or more payment amount portions. Further, the one or more payment amount portions are equal. Further, the processing device 204 may be configured for allocating the one or more payment amount portions to the one or more accounts based on the dividing. Further, the comparing may include comparing each fund of the one or more funds associated with each account of the one or more accounts with each payment amount portion of the one or more payment amount portions allotted to each account of the one or more accounts. Further, the determining of the account fund sufficiency for each account of the one or more accounts may be based on the comparing of each fund of the one or more funds associated with each account of the one or more accounts with each payment amount portion of the one or more payment amount portions allotted to each account of the one or more accounts.

Further, in some embodiments, the identifying of the at least one account from the one or more accounts may be based on the determining of the account fund sufficiency for each account of the one or more accounts. Further, each account of the at least one account may include a fund for paying a payment amount portion of the one or more payment amount portions allotted to each account of the at least one account.

Further, in some embodiments, the processing device 204 may be configured for identifying at least one first account of the one or more accounts based on the determining of the account fund sufficiency for each account of the one or more accounts. Further, each account of the at least one account does not comprise a first fund for paying a first payment amount portion of the one or more payment amount portion allotted to each first account of the at least one first account. Further, the processing device 204 may be configured for determining a first payment amount of the payment amount based on the identifying of the at least one first account. Further, the first payment amount may include at least one first payment amount portion allotted to the at least one first account. Further, the processing device 204 may be configured for dividing the first payment amount into at least one first payment amount portion based on the determining of the first payment amount. Further, the processing device 204 may be configured for allotting the at least one first payment amount portion to the at least one account based on the dividing of the first payment amount. Further, each account of the at least one account may include a fund for paying a first payment amount portion of the at least one first payment amount portion allotted to each account of the at least one account.

Further, in some embodiments, the dividing of the first payment amount into the at least one first payment amount portion may include dividing the first payment amount into the at least one first payment amount portion for the at least one account based on the account fund sufficiency. Further, the at least one first payment amount portion corresponds to the account fund sufficiency of each account of the at least one account.

Further, in some embodiments, the one or more account data may include one or more transaction amount restrictions for the one or more accounts. Further, the analyzing may include analyzing the one or more transaction amount restrictions with the payment amount. Further, the determining of the account preferability may be based on the analyzing of the one or more transaction amount limitations.

Further, in some embodiments, the processing device 204 may be configured for dividing the payment amount into at least one payment amount portion based on at least one user defined transaction amount restriction. Further, the processing device 204 may be configured for allocating the at least one payment amount portion to the at least one account based on the dividing of the payment amount. Further, the at least one payment amount potion may be transacted from the at least one account based on the authorizing and the allocating.

Further, in some embodiments, the communication device 202 may be configured for receiving the at least one user defined transaction amount restriction associated with the at least one account from at least one user device.

Further, in some embodiments, the one or more account data may include one or more account parameters of the one or more accounts. Further, the payment request data may include at least one requirement for paying the payment amount. Further, the analyzing may include analyzing the one or more account parameters with the at least one requirement. Further, the account preferability may include an account compatibility of the one or more accounts for making the at least one transaction. Further, the determining of the account preferability may include determining the account compatibility for the one or more accounts. Further, the identifying of the at least one account from the one or more accounts may be further based on the determining of the account compatibility.

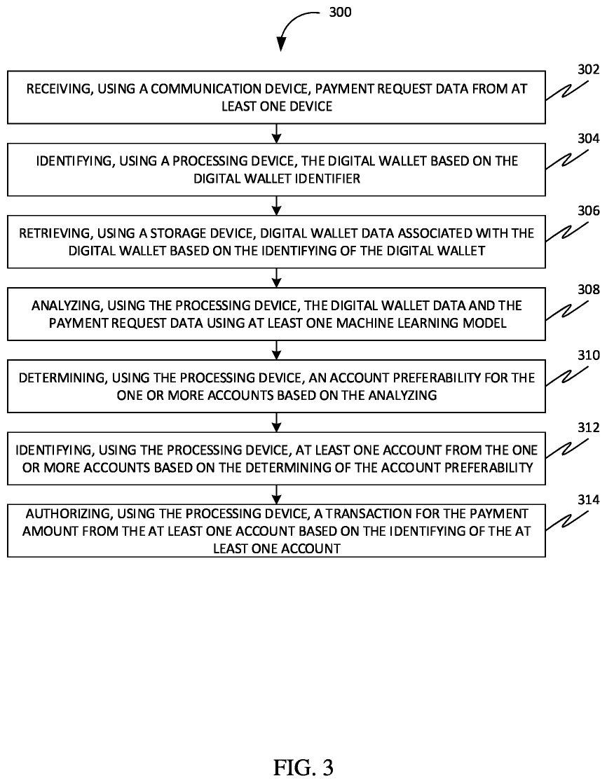

FIG. 3 is a flow chart of a method 300 for facilitating managing of payments made using digital wallets, in accordance with some embodiments. Accordingly, at 302, the method 300 may include receiving, using a communication device (such as the communication device 202), payment request data from at least one device. Further, the payment request data may include a payment amount and a digital wallet identifier associated with a digital wallet.

Further, at 304, the method 300 may include identifying, using a processing device (such as the processing device 204), the digital wallet based on the digital wallet identifier.

Further, at 306, the method 300 may include retrieving, using a storage device (such as the storage device 206), digital wallet data associated with the digital wallet based on the identifying of the digital wallet. Further, the digital wallet data may include one or more account data associated with one or more accounts of the digital wallet.

Further, at 308, the method 300 may include analyzing, using the processing device, the digital wallet data and the payment request data using at least one machine learning model.

Further, at 310, the method 300 may include determining, using the processing device, an account preferability for the one or more accounts based on the analyzing.

Further, at 312, the method 300 may include identifying, using the processing device, at least one account from the one or more accounts based on the determining of the account preferability.

Further, at 314, the method 300 may include authorizing, using the processing device, a transaction for the payment amount from the at least one account based on the identifying of the at least one account. Further, the payment amount may be transacted from the at least one account based on the authorizing.

Further, in some embodiments, the one or more account data may include one or more funds available in the one or more accounts. Further, the analyzing may include comparing the one or more funds with the payment amount. Further, the account preferability may include an account fund sufficiency of the one or more accounts. Further, the determining of the account preferability may include determining the account fund sufficiency for the one or more accounts based on the comparing. Further, the identifying of the at least one account from the one or more accounts may be based on the determining of the account fund sufficiency.

Further, in some embodiments, the one or more account data may include one or more transaction amount restrictions for the one or more accounts. Further, the analyzing may include analyzing the one or more transaction amount restrictions with the payment amount. Further, the determining of the account preferability may be based on the analyzing of the one or more transaction amount limitations.

Further, in some embodiments, the one or more account data may include one or more account parameters of the one or more accounts. Further, the payment request data may include at least one requirement for paying the payment amount. Further, the analyzing may include analyzing the one or more account parameters with the at least one requirement. Further, the account preferability may include an account compatibility of the one or more accounts for making the at least one transaction. Further, the determining of the account preferability may include determining the account compatibility for the one or more accounts. Further, the identifying of the at least one account from the one or more accounts may be based on the determining of the account compatibility.

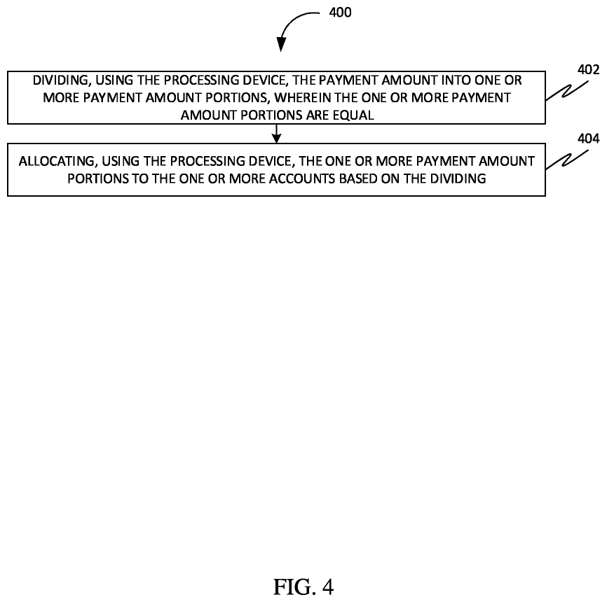

FIG. 4 is a flow chart of a method 400 for allocating the one or more payment amount portions for facilitating managing of payments made using digital wallets, in accordance with some embodiments. Accordingly, at 402, the method 400 may include dividing, using the processing device, the payment amount into one or more payment amount portions. Further, the one or more payment amount portions are equal.

Further, at 404, the method 400 may include allocating, using the processing device, the one or more payment amount portions to the one or more accounts based on the dividing. Further, the comparing may include comparing each fund of the one or more funds associated with each account of the one or more accounts with each payment amount portion of the one or more payment amount portions allotted to each account of the one or more accounts. Further, the determining of the account fund sufficiency for each account of the one or more accounts may be based on the comparing of each fund of the one or more funds associated with each account of the one or more accounts with each payment amount portion of the one or more payment amount portions allotted to each account of the one or more accounts.

Further, in some embodiments, the identifying of the at least one account from the one or more accounts may be based on the determining of the account fund sufficiency for each account of the one or more accounts. Further, each account of the at least one account may include a fund for paying a payment amount portion of the one or more payment amount portions allotted to each account of the at least one account.

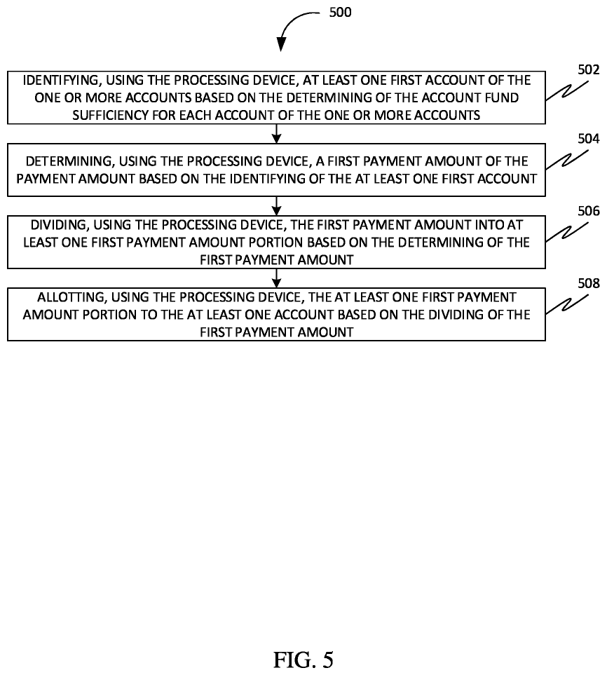

FIG. 5 is a flow chart of a method 500 for allotting the at least one first payment amount portion for facilitating managing of payments made using digital wallets, in accordance with some embodiments. Accordingly, at 502, the method 500 may include identifying, using the processing device, at least one first account of the one or more accounts based on the determining of the account fund sufficiency for each account of the one or more accounts. Further, each account of the at least one account does not comprise a first fund for paying a first payment amount portion of the one or more payment amount portion allotted to each first account of the at least one first account.

Further, at 504, the method 500 may include determining, using the processing device, a first payment amount of the payment amount based on the identifying of the at least one first account. Further, the first payment amount may include at least one first payment amount portion allotted to the at least one first account.

Further, at 506, the method 500 may include dividing, using the processing device, the first payment amount into at least one first payment amount portion based on the determining of the first payment amount.

Further, at 508, the method 500 may include allotting, using the processing device, the at least one first payment amount portion to the at least one account based on the dividing of the first payment amount. Further, each account of the at least one account may include a fund for paying a first payment amount portion of the at least one first payment amount portion allotted to each account of the at least one account.

Further, in some embodiments, the dividing of the first payment amount into the at least one first payment amount portion may include dividing the first payment amount into the at least one first payment amount portion for the at least one account based on the account fund sufficiency. Further, the at least one first payment amount portion corresponds to the account fund sufficiency of each account of the at least one account.

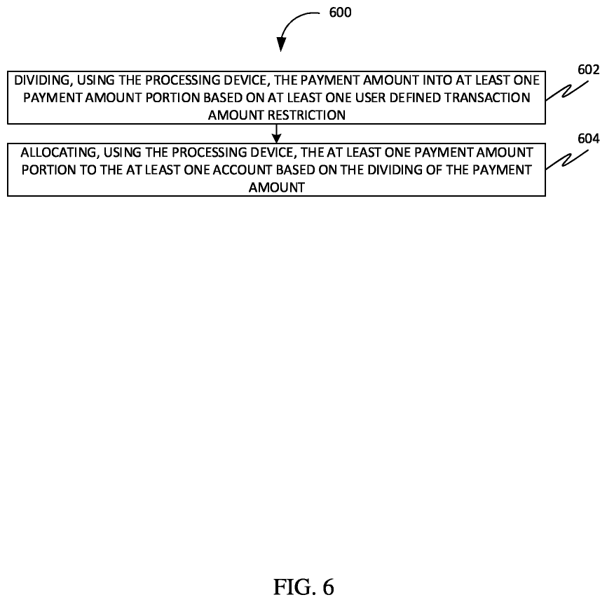

FIG. 6 is a flow chart of a method 600 for allotting the at least one payment amount portion for facilitating managing of payments made using digital wallets, in accordance with some embodiments. Accordingly, at 602, the method 600 may include dividing, using the processing device, the payment amount into at least one payment amount portion based on at least one user defined transaction amount restriction.

Further, at 604, the method 600 may include allocating, using the processing device, the at least one payment amount portion to the at least one account based on the dividing of the payment amount. Further, the at least one payment amount potion may be transacted from the at least one account based on the authorizing and the allocating.

Further, the method 600 may include receiving, using the communication device, the at least one user defined transaction amount restriction associated with the at least one account from at least one user device.

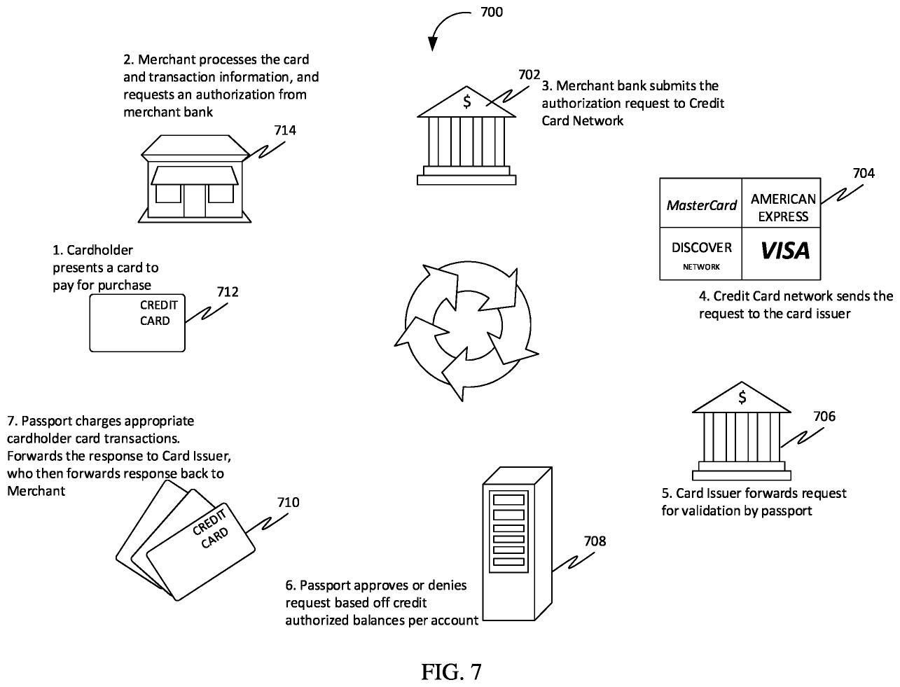

FIG. 7 is a flow diagram of a method 700 for facilitating managing of payments made using digital wallets, in accordance with some embodiments. Accordingly, at 712, the method 700 may include a cardholder presenting a card to purchase. Further, at 714, the method 700 may include a merchant processing card and transaction information. Further, at 702, the method 700 may include a merchant bank submitting the authorization request to credit card network. Further, at 704, the method 700 may include the credit card network sending the request to a card issuer. Further, at 706, the method 700 may include a card issuer forwarding the request for validation by passport system. Further, at 708, the method 700 may include the passport system approving or denying the request based off credit authorized balances per amount. Further, at 710, the method 700 may include the passport system charging appropriate cardholder card transactions.

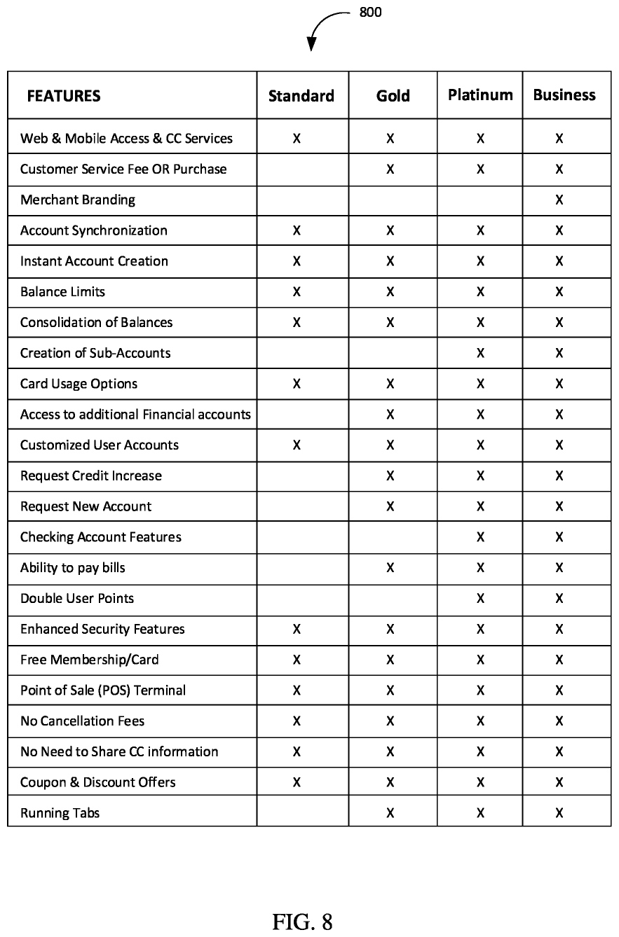

FIG. 8 is a tabular representation 800 of user plans associated with the disclosed system for facilitating managing of payments made using digital wallets, in accordance with some embodiments.

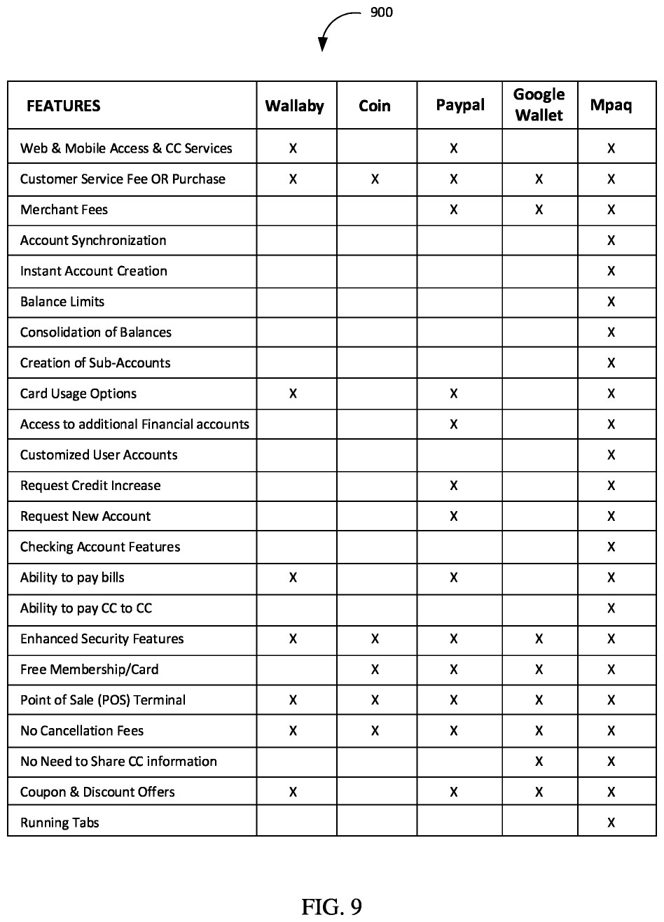

FIG. 9 is a tabular representation 900 illustrating features provided by some conventional systems, in accordance with some embodiments.

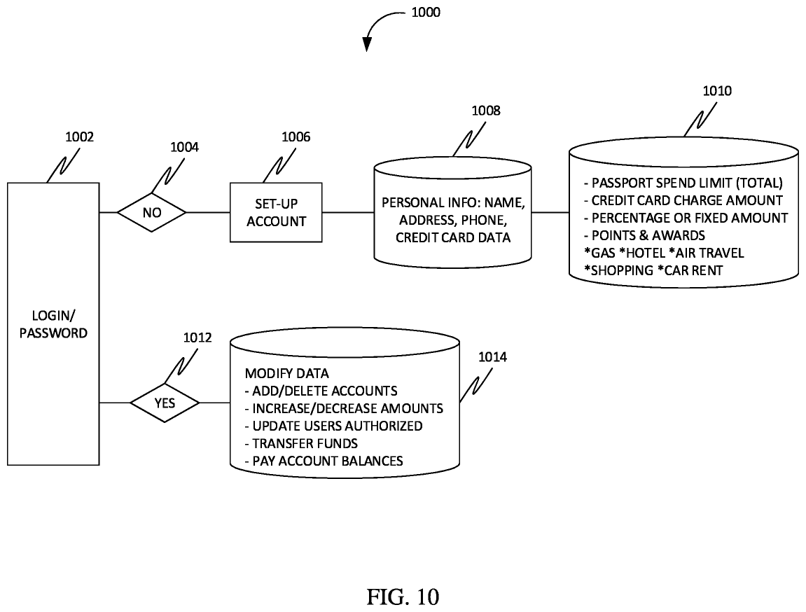

FIG. 10 is a flow diagram of a method 1000 for facilitating registration and account maintenance, in accordance with some embodiments. Accordingly, at 1002, the method 1000 may include receiving login id and password. Further, at 1004, the method 1000 may include a registration result No. Further, at 1006, the method 1000 may include setting up account. Further, at 1008, the method 1000 may include storing personal information. Further, at 1010, the method 1000 may include storing passport spend limit, credit card charge amount, percentage amount, etc. Further, at 1012, the method 1000 may include registration result yes. Further, at 1014, the method 1000 may include modifying data.

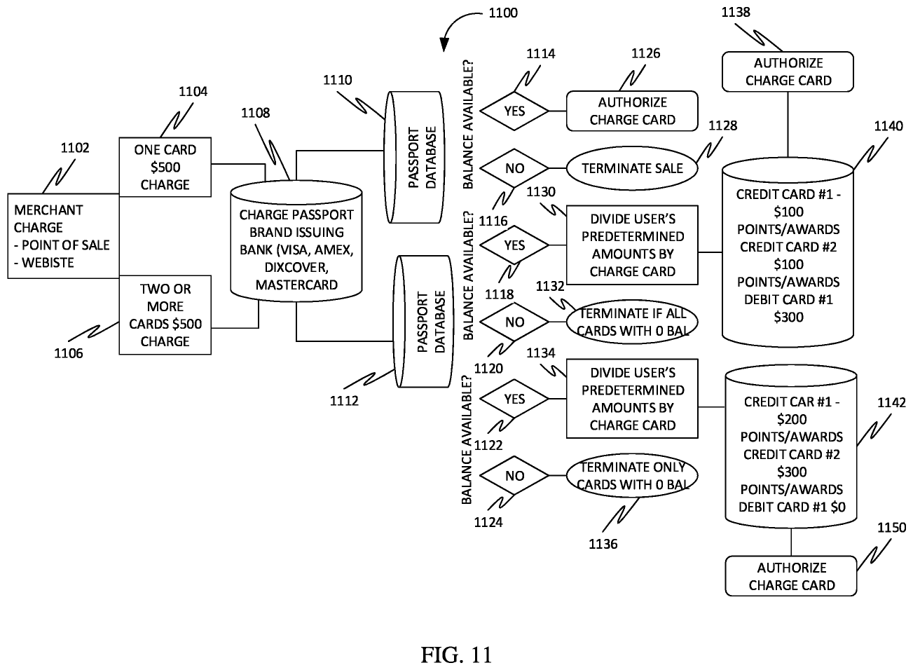

FIG. 11 is a flow diagram of a method 1100 for facilitating multi card transaction, in accordance with some embodiments. Accordingly, at 1102, the method 1100 may include a merchant charge. Further, at 1104, the method 1100 may include one card $500 charge. Further, at 1106, the method 1100 may include two or more cards $500 charge. Further, at 1108, the method 1100 may include charge passport brand issuing bank such as Visa, AmEx, etc. Further, at 1110, the method 1100 may include checking passport database if balance is available. Further, at 1114, the method 1100 may include a checking result yes. Further, at 1126, the method 1100 may include authorizing charge card. Further, at 1116, the method 1100 may include a checking result no. Further, at 1128, the method 1300 may include terminating sale. Further, at 1112, the method 1100 may include checking passport database if balance is available. Further, at 1118, the method 1100 may include a checking result yes. Further, at 1130, the method 1100 may include dividing users predetermined amounts. Further, at 1140, the method 1100 may include points/rewards associated with credit cards. Further, at 1138, the method 1100 may include authorizing charge card. Further, at 1120, the method 1100 may include a checking result no. Further, at 1132, the method 1300 may include terminating if all cards with zero balance. Further, at 1122, the method 1100 may include a checking result yes. Further, at 1134, the method 1100 may include dividing users predetermined amounts. Further, at 1142, the method 1100 may include points/rewards associated with credit cards. Further, at 1150, the method 1100 may include authorizing charge card. Further, at 1124, the method 1100 may include a checking result no. Further, at 1136, the method 1300 may include terminating if all cards with zero balance. If one or more credit/debit cards do not have a sufficient balance, Passport system (or the disclosed system) may automatically pull the difference from other accounts based on availability.

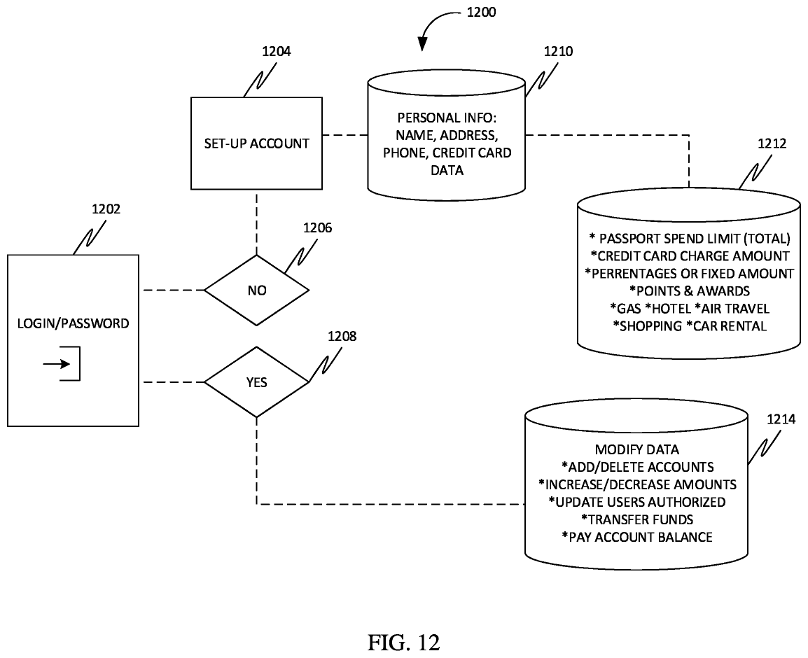

FIG. 12 is a flow diagram of a method 1200 for facilitating registration and account maintenance, in accordance with some embodiments. Accordingly, at 1202, the method 1200 may include receiving login id and password. Further, at 1204, the method 1200 may include a registration result No. Further, at 1206, the method 1200 may include setting up account. Further, at 1208, the method 1200 may include storing personal information. Further, at 1210, the method 1200 may include storing passport spend limit, credit card charge amount, percentage amount, etc. Further, at 1212, the method 1200 may include registration result yes. Further, at 1214, the method 1200 may include modifying data.

Further, the method 1200 may include initializing steps for the disclosed system. Further, the disclosed method 1200 may include account creation. Further, the method 1200 may include additional custom configurations available for an already existent account.

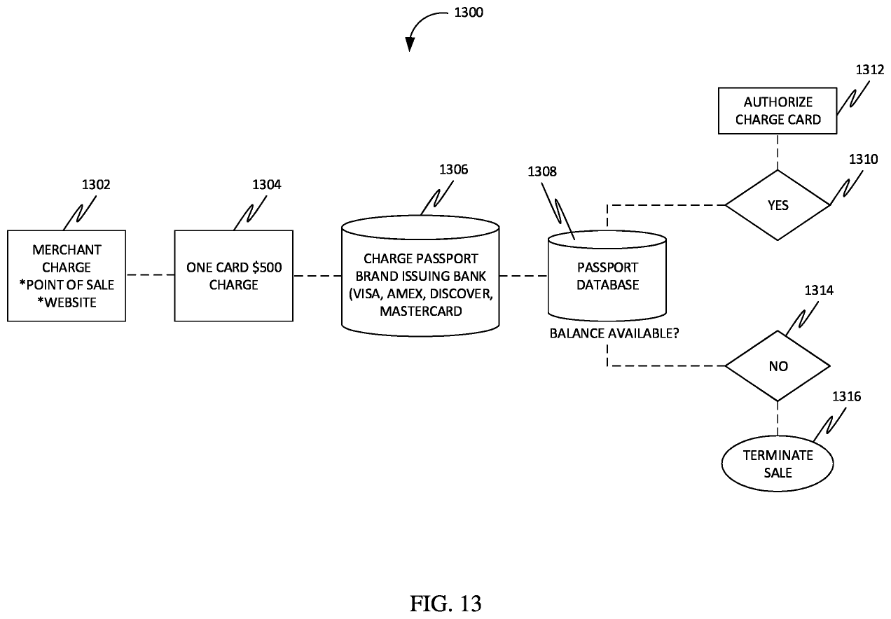

FIG. 13 is a flow diagram of a method 1300 for facilitating single card transaction, in accordance with some embodiments. Accordingly, at 1302, the method 1300 may include a merchant charge. Further, at 1304, the method 1300 may include one card $500 charge. Further, at 1306, the method 1300 may include charge passport brand issuing bank such as Visa, AmEx, etc. Further, at 1308, the method 1300 may include checking passport database if balance is available. Further, at 1310, the method 1300 may include a checking result yes. Further, at 1312, the method 1300 may include authorizing charge card. Further, at 1314, the method 1300 may include a checking result no. Further, at 1316, the method 1300 may include terminating sale.

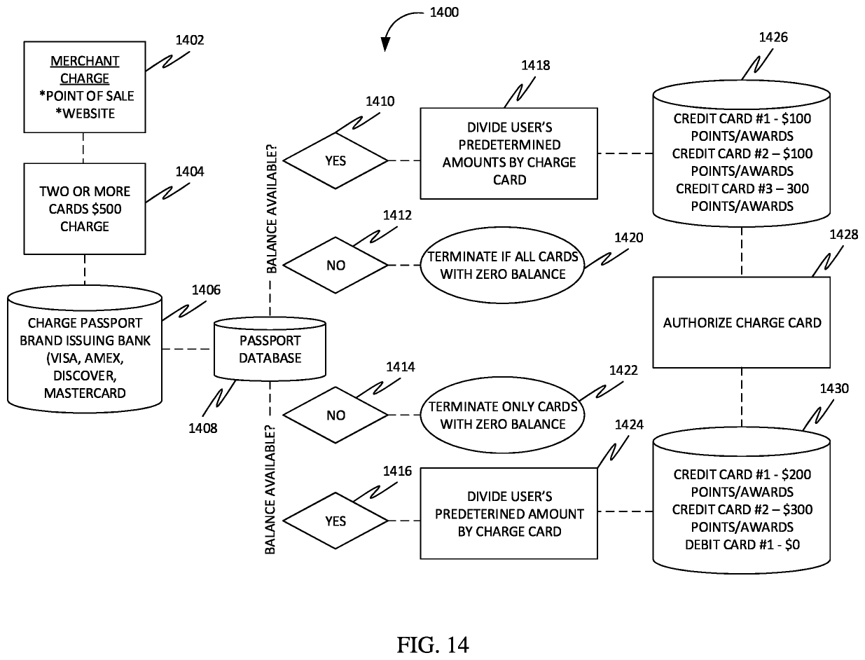

FIG. 14 is a flow diagram of a method 1400 for facilitating multi card transaction, in accordance with some embodiments. Accordingly, at 1402, the method 1400 may include a merchant charge. Further, at 1404, the method 1400 may include two or more cards $500 charge. Further, at 1406, the method 1400 may include charge passport brand issuing bank such as Visa, AmEx, etc. Further, at 1408, the method 1400 may include checking passport database if balance is available. Further, at 1410, the method 1400 may include a checking result yes. Further, at 1418, the method 1400 may include dividing user's predetermined amount by charge card. Further, at 1426, the method 1400 may include storing points/rewards associated with credit cards. Further, at 1428, the method 1400 may include authorizing charge card. Further, at 1412, the method 1400 may include a checking result no. Further, at 1420, the method 1400 may include terminating if all cards are with zero balance. Further, at 1416, the method 1400 may include a checking result yes. Further, at 1424, the method 1400 may include dividing user's predetermined amount by charge card. Further, at 1430, the method 1400 may include storing points/rewards associated with credit cards. Further, at 1428, the method 1400 may include authorizing charge card. Further, at 1414, the method 1400 may include a checking result no. Further, at 1422, the method 1400 may include terminating if all cards are with zero balance.

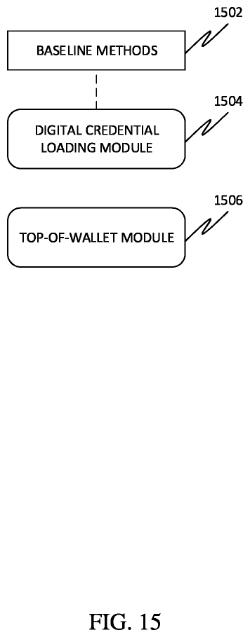

FIG. 15 is a flow chart of a baseline method 1502 associated with the disclosed system for facilitating managing of payments made using digital wallets, in accordance with some embodiments. Accordingly, the baseline method 1502 may be associated with a digital credential loading module 1504 and a top-of-wallet module 1506.

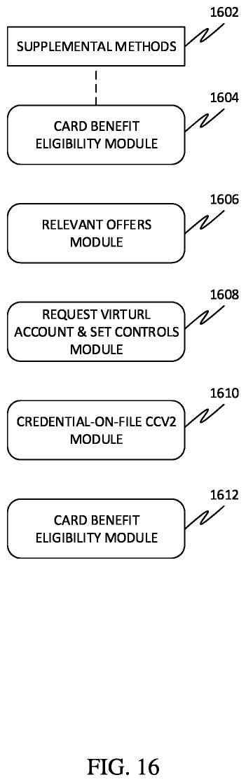

FIG. 16 is a flow chart of a supplemental method 1602 associated with the disclosed system for facilitating managing of payments made using digital wallets, in accordance with some embodiments. Accordingly, the supplemental method 1602 may be associated with a card benefit eligibility module 1604, a relevant offers module 1606, a request virtual account module 1608, credential-on-file CCV2 module 1610, and a card benefit eligibility module 1612.

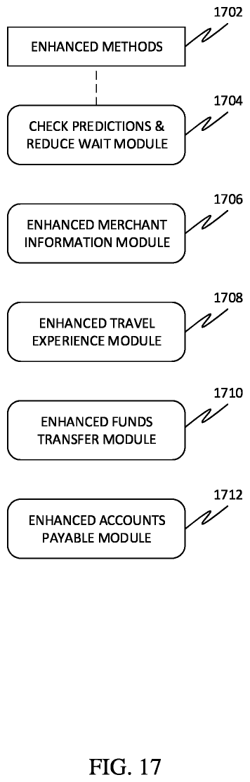

FIG. 17 is a flow chart of an enhanced method 1702 associated with the disclosed system for facilitating managing of payments made using digital wallets, in accordance with some embodiments. Accordingly, the enhanced method 1702 may be associated with a check predication and reduce wait module 1704, an enhanced merchant information module 1706, an enhanced travel experience module 1708, enhanced funds transfer module 1710, and an enhanced accounts payable module 1712.

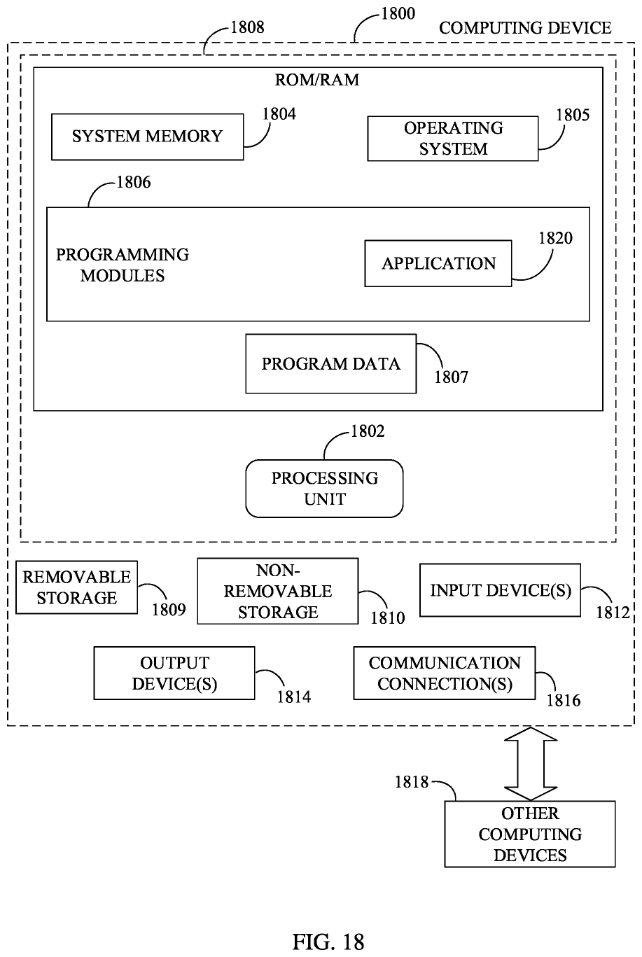

With reference to FIG. 18, a system consistent with an embodiment of the disclosure may include a computing device or cloud service, such as computing device 1800. In a basic configuration, computing device 1800 may include at least one processing unit 1802 and a system memory 1804. Depending on the configuration and type of computing device, system memory 1804 may comprise, but is not limited to, volatile (e.g. random-access memory (RAM)), non-volatile (e.g. read-only memory (ROM)), flash memory, or any combination. System memory 1804 may include operating system 1805, one or more programming modules 1806, and may include a program data 1807. Operating system 1805, for example, may be suitable for controlling computing device 1800's operation. In one embodiment, programming modules 1806 may include image-processing module, machine learning module. Furthermore, embodiments of the disclosure may be practiced in conjunction with a graphics library, other operating systems, or any other application program and is not limited to any particular application or system. This basic configuration is illustrated in FIG. 18 by those components within a dashed line 1808.

Computing device 1800 may have additional features or functionality. For example, computing device 1800 may also include additional data storage devices (removable and/or non-removable) such as, for example, magnetic disks, optical disks, or tape. Such additional storage is illustrated in FIG. 18 by a removable storage 1809 and a non-removable storage 1810. Computer storage media may include volatile and non-volatile, removable and non-removable media implemented in any method or technology for storage of information, such as computer-readable instructions, data structures, program modules, or other data. System memory 1804, removable storage 1809, and non-removable storage 1810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1800. Any such computer storage media may be part of device 1800. Computing device 1800 may also have input device(s) 1812 such as a keyboard, a mouse, a pen, a sound input device, a touch input device, a location sensor, a camera, a biometric sensor, etc. Output device(s) 1814 such as a display, speakers, a printer, etc. may also be included. The aforementioned devices are examples and others may be used.

Computing device 1800 may also contain a communication connection 1816 that may allow device 1800 to communicate with other computing devices 1818, such as over a network in a distributed computing environment, for example, an intranet or the Internet. Communication connection 1816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1804, including operating system 1805. While executing on processing unit 1802, programming modules 1806 (e.g., application 1820 such as a media player) may perform processes including, for example, one or more stages of methods, algorithms, systems, applications, servers, databases as described above. The aforementioned process is an example, and processing unit 1802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating managing of payments made using digital wallets, the method comprising:
receiving, using a communication device, payment request data from at least one device, wherein the payment request data comprises a payment amount and a digital wallet identifier associated with a digital wallet;
identifying, using a processing device, the digital wallet based on the digital wallet identifier;
retrieving, using a storage device, digital wallet data associated with the digital wallet based on the identifying of the digital wallet, wherein the digital wallet data comprises one or more account data associated with one or more accounts of the digital wallet;
analyzing, using the processing device, the digital wallet data and the payment request data using at least one machine learning model;
determining, using the processing device, an account preferability for the one or more accounts based on the analyzing;
identifying, using the processing device, at least one account from the one or more accounts based on the determining of the account preferability; and
authorizing, using the processing device, a transaction for the payment amount from the at least one account based on the identifying of the at least one account, wherein the payment amount is transacted from the at least one account based on the authorizing.

2. The method of claim 1, wherein the one or more account data comprises one or more funds available in the one or more accounts, wherein the analyzing comprises comparing the one or more funds with the payment amount, wherein the account preferability comprises an account fund sufficiency of the one or more accounts, wherein the determining of the account preferability comprises determining the account fund sufficiency for the one or more accounts based on the comparing, wherein the identifying of the at least one account from the one or more accounts is further based on the determining of the account fund sufficiency.

3. The method of claim 2 further comprising:
dividing, using the processing device, the payment amount into one or more payment amount portions, wherein the one or more payment amount portions are equal; and
allocating, using the processing device, the one or more payment amount portions to the one or more accounts based on the dividing, wherein the comparing comprises comparing each fund of the one or more funds associated with each account of the one or more accounts with each payment amount portion of the one or more payment amount portions allotted to each account of the one or more accounts, wherein the determining of the account fund sufficiency for each account of the one or more accounts is further based on the comparing of each fund of the one or more funds associated with each account of the one or more accounts with each payment amount portion of the one or more payment amount portions allotted to each account of the one or more accounts.

4. The method of claim 3, wherein the identifying of the at least one account from the one or more accounts is further based on the determining of the account fund sufficiency for each account of the one or more accounts, wherein each account of the at least one account comprises a fund for paying a payment amount portion of the one or more payment amount portions allotted to each account of the at least one account.

5. The method of claim 3 further comprising:
identifying, using the processing device, at least one first account of the one or more accounts based on the determining of the account fund sufficiency for each account of the one or more accounts, wherein each account of the at least one account does not comprise a first fund for paying a first payment amount portion of the one or more payment amount portion allotted to each first account of the at least one first account;
determining, using the processing device, a first payment amount of the payment amount based on the identifying of the at least one first account, wherein the first payment amount comprises at least one first payment amount portion allotted to the at least one first account;
dividing, using the processing device, the first payment amount into at least one first payment amount portion based on the determining of the first payment amount; and
allotting, using the processing device, the at least one first payment amount portion to the at least one account based on the dividing of the first payment amount, wherein each account of the at least one account further comprises a fund for paying a first payment amount portion of the at least one first payment amount portion allotted to each account of the at least one account.

6. The method of claim 5, wherein the dividing of the first payment amount into the at least one first payment amount portion comprises dividing the first payment amount into the at least one first payment amount portion for the at least one account based on the account fund sufficiency, wherein the at least one first payment amount portion corresponds to the account fund sufficiency of each account of the at least one account.

7. The method of claim 1, wherein the one or more account data comprises one or more transaction amount restrictions for the one or more accounts, wherein the analyzing comprises analyzing the one or more transaction amount restrictions with the payment amount, wherein the determining of the account preferability is further based on the analyzing of the one or more transaction amount limitations.

8. The method of claim 1 further comprising:
dividing, using the processing device, the payment amount into at least one payment amount portion based on at least one user defined transaction amount restriction; and
allocating, using the processing device, the at least one payment amount portion to the at least one account based on the dividing of the payment amount, wherein the at least one payment amount potion is transacted from the at least one account based on the authorizing and the allocating.

9. The method of claim 8 further comprising receiving, using the communication device, the at least one user defined transaction amount restriction associated with the at least one account from at least one user device.

10. The method of claim 1, wherein the one or more account data comprises one or more account parameters of the one or more accounts, wherein the payment request data comprises at least one requirement for paying the payment amount, wherein the analyzing comprises analyzing the one or more account parameters with the at least one requirement, wherein the account preferability comprises an account compatibility of the one or more accounts for making the at least one transaction, wherein the determining of the account preferability comprises determining the account compatibility for the one or more accounts, wherein the identifying of the at least one account from the one or more accounts is further based on the determining of the account compatibility.

11. A system for facilitating managing of payments made using digital wallets, the system comprising:
a communication device configured for receiving payment request data from at least one device, wherein the payment request data comprises a payment amount and a digital wallet identifier associated with a digital wallet;
a processing device communicatively coupled with the communication device, wherein the processing device is configured for:
identifying the digital wallet based on the digital wallet identifier;
analyzing digital wallet data and the payment request data using at least one machine learning model, wherein the digital wallet data comprises one or more account data associated with one or more accounts of the digital wallet;
determining an account preferability for the one or more accounts based on the analyzing;
identifying at least one account from the one or more accounts based on the determining of the account preferability; and
authorizing a transaction for the payment amount from the at least one account based on the identifying of the at least one account, wherein the payment amount is transacted from the at least one account based on the authorizing; and
a storage device communicatively coupled with the processing device, wherein the storage device is configured for retrieving the digital wallet data associated with the digital wallet based on the identifying of the digital wallet.

12. The system of claim 11, wherein the one or more account data comprises one or more funds available in the one or more accounts, wherein the analyzing comprises comparing the one or more funds with the payment amount, wherein the account preferability comprises an account fund sufficiency of the one or more accounts, wherein the determining of the account preferability comprises determining the account fund sufficiency for the one or more accounts based on the comparing, wherein the identifying of the at least one account from the one or more accounts is further based on the determining of the account fund sufficiency.

13. The system of claim 12, wherein the processing device is further configured for:
dividing the payment amount into one or more payment amount portions, wherein the one or more payment amount portions are equal; and
allocating the one or more payment amount portions to the one or more accounts based on the dividing, wherein the comparing comprises comparing each fund of the one or more funds associated with each account of the one or more accounts with each payment amount portion of the one or more payment amount portions allotted to each account of the one or more accounts, wherein the determining of the account fund sufficiency for each account of the one or more accounts is further based on the comparing of each fund of the one or more funds associated with each account of the one or more accounts with each payment amount portion of the one or more payment amount portions allotted to each account of the one or more accounts.

14. The system of claim 13, wherein the identifying of the at least one account from the one or more accounts is further based on the determining of the account fund sufficiency for each account of the one or more accounts, wherein each account of the at least one account comprises a fund for paying a payment amount portion of the one or more payment amount portions allotted to each account of the at least one account.

15. The system of claim 13, wherein the processing device is further configured for:
identifying at least one first account of the one or more accounts based on the determining of the account fund sufficiency for each account of the one or more accounts, wherein each account of the at least one account does not comprise a first fund for paying a first payment amount portion of the one or more payment amount portion allotted to each first account of the at least one first account;
determining a first payment amount of the payment amount based on the identifying of the at least one first account, wherein the first payment amount comprises at least one first payment amount portion allotted to the at least one first account;
dividing the first payment amount into at least one first payment amount portion based on the determining of the first payment amount; and
allotting the at least one first payment amount portion to the at least one account based on the dividing of the first payment amount, wherein each account of the at least one account further comprises a fund for paying a first payment amount portion of the at least one first payment amount portion allotted to each account of the at least one account.

16. The system of claim 15, wherein the dividing of the first payment amount into the at least one first payment amount portion comprises dividing the first payment amount into the at least one first payment amount portion for the at least one account based on the account fund sufficiency, wherein the at least one first payment amount portion corresponds to the account fund sufficiency of each account of the at least one account.

17. The system of claim 11, wherein the one or more account data comprises one or more transaction amount restrictions for the one or more accounts, wherein the analyzing comprises analyzing the one or more transaction amount restrictions with the payment amount, wherein the determining of the account preferability is further based on the analyzing of the one or more transaction amount limitations.

18. The system of claim 11, wherein the processing device is further configured for:
dividing the payment amount into at least one payment amount portion based on at least one user defined transaction amount restriction; and
allocating the at least one payment amount portion to the at least one account based on the dividing of the payment amount, wherein the at least one payment amount potion is transacted from the at least one account based on the authorizing and the allocating.

19. The system of claim 18, wherein the communication device is further configured for receiving the at least one user defined transaction amount restriction associated with the at least one account from at least one user device.

20. The system of claim 11, wherein the one or more account data comprises one or more account parameters of the one or more accounts, wherein the payment request data comprises at least one requirement for paying the payment amount, wherein the analyzing comprises analyzing the one or more account parameters with the at least one requirement, wherein the account preferability comprises an account compatibility of the one or more accounts for making the at least one transaction, wherein the determining of the account preferability comprises determining the account compatibility for the one or more accounts, wherein the identifying of the at least one account from the one or more accounts is further based on the determining of the account compatibility.
